(19) United States
(12) Patent Application Publication
(10) Pub. No.: US 2011/0239708 A1
(43) Pub. Date: Oct. 6, 2011

(54) APPARATUS FOR MANUFACTURING GLASS SHEET

(76) Inventors: Noritomo Nishiura, Shiga (JP); koji Domori, Shiga (JP); Yasuo Yamazaki, Shiga (JP); Kouki Ueda, Shiga (JP)

(21) Appl. No.: 13/131,629

(22) PCT Filed: Sep. 29, 2009
(86) PCT No.: PCT/JP2009/066882

§ 371 Date: May 27, 2011

(30) Foreign Application Priority Data
Dec. 19, 2008 (JP) 2008324267

(51) Int. Cl. C03B 17/06

(52) U.S. Cl. 65/199

(57) ABSTRACT

Provided is an apparatus (1) for manufacturing a glass sheet, which has such a structure that a pair of cooling rollers (5) sandwich, from both front and back sides of a glass ribbon (G), each end portion (Ga) in a width direction of the glass ribbon (G) that is produced by causing molten glass (g) to flow down from a forming trough (3), and a roller shaft (5a) of each of the pair of cooling rollers (5) is arrayed so as to extend from a center side to each end side in the width direction of the glass ribbon (G), in which each of the pair of cooling rollers (5) catches the glass ribbon (G) on an outer peripheral surface thereof, to thereby inhibit contraction in the width direction of the glass ribbon (G).

### TECHNICAL FIELD

The present invention relates to an apparatus for manufacturing a glass sheet, and more particularly, to an apparatus for manufacturing a glass sheet, which includes cooling rollers for sandwiching, from front and back sides of a glass ribbon, each end portion in a width direction of the glass ribbon that is produced by causing molten glass to flow down from a forming body.

### BACKGROUND ART

In recent years, along with development of electronic devices and the like, a wide variety of glass sheets are used for a flat panel display (FPD) including a liquid crystal display, a plasma display, a field emission display (including surface-conduction electron-emitter display), and an electroluminescent display, a substrate for a sensor, a cover for a semiconductor package including a solid state imaging device and a laser diode, a substrate for a compound thin-film solar cell, and the like.

As a method of manufacturing the glass sheet of this type, there are widely adopted a method called an overflow down-draw method or a slot down-draw method in which a sheet-like glass ribbon is produced by causing molten glass to flow down, and the molten glass is solidified while further flowing down, to thereby form the sheet-like glass ribbon, and a method called a float method in which the molten glass is solidified while flowing out onto molten metal or to gas such as vapor, to thereby form the sheet-like glass ribbon.

In particular, the overflow down-draw method has the following initial stage. Specifically, the molten glass is supplied to an upper portion of a forming body formed of a heat-resisting member having a cylindrical shape or a triangular prism shape (wedge shape). Then, the molten glass overflowing from an upper end of the forming body is caused to flow down along both side surfaces of the forming body, and caused to interflow at a lower end of the forming body, to thereby produce a sheet-like glass ribbon. In this case, the glass ribbon produced directly below the forming body still has a low viscosity, which causes the glass ribbon to contract in a width direction due to its surface tension.

In this context, in the initial stage of forming the glass sheet, for the purpose of causing the glass ribbon to keep a predetermined width, there are provided pairs of (two pairs in total) cooling rollers (Knurled Roll (wheel)) for sandwiching, from front and back sides of the glass ribbon, both end portions in the width direction of the glass ribbon directly below the forming body, and the cooling rollers cool the both end portions in the width direction of the glass ribbon (see Patent Literatures 1, 2, and 3). In this way, directly below the forming body, cooling of the glass ribbon and solidification accompanied with the cooling are accelerated, and at a point in time when the glass ribbon further flows down to reach near room temperature, the glass ribbon is cut into a predetermined length, to thereby manufacture a desired glass sheet.

In the overflow down-draw method, an attempt has been made to cope with insufficient cooling of the glass ribbon, contraction in the width direction of the glass ribbon, and the like by improvement of an array relation of the cooling rollers. Specifically, Patent Literature 4 discloses that the number of the cooling rollers is increased by providing the cooling rollers in a plurality of stages, to thereby enhance a cooling effect with respect to the glass ribbon. Further, Patent Literature 5 discloses such a configuration that, by inclining roller shafts of the cooling rollers, friction occurring between the glass ribbon and the cooling rollers at the time of rotation of the cooling rollers can impart a stretching force to the glass ribbon.

Note that, Patent Literature 6 discloses the following. Specifically, a pair of rolls having protruding portions are arranged in the vicinity of both ends in the width direction of the glass ribbon that is supplied onto a support (onto a horizontal surface) in a molten state, and the rolls are rotated about shafts in a width stretching direction of the glass ribbon, to thereby impart stretching stress in the width direction to the glass ribbon.

### CITATION LIST

### Patent Literature

Patent Literature 1: Japanese Examined Patent Publication No. Sho 38-17820
Patent Literature 2: JP 60-11235 A
Patent Literature 3: JP 2007-528338 A
Patent Literature 4: JP 2007-51028 A
Patent Literature 5: JP 10-291826 A
Patent Literature 6: JP 2002-47017 A

### SUMMARY OF INVENTION

### Technical Problem

In general, the above-mentioned overflow down-draw method has, as illustrated in FIG. 12, characteristics that a sheet thickness to of each end portion Ga (region that is not used as the glass sheet, i.e., a product and is discarded) in a width direction of a glass ribbon G becomes thicker than a sheet thickness tb of a product region Gb (region that is used as the glass sheet, i.e., a product in future) of the glass ribbon G. Such a situation is significant particularly under the current circumstances in which a size of the glass sheet for the FPD is increased in order to meet demand for improvement of production efficiency of the FPD, and a sheet thickness thereof is reduced in order to meet demand for light-weight of the FPD.

In addition, under the current circumstances described above, from demand for an increase in production amount per unit time, an amount of heat that is transferred per unit time increases along with an increase in amount of molten glass that is supplied to the forming body to flow down. Consequently, the each end portion in the width direction of the glass ribbon cannot be cooled by the cooling rollers sufficiently, which causes contraction of glass. Thus, as illustrated in FIG. 13, the sheet thickness ta of the each end portion Ga in the width direction of the glass ribbon G increases in comparison with the sheet thickness tb of the product region Gb. When this situation occurs, not only is there a large difference between the sheet thickness ta of the each end portion Ga in the width direction of the glass ribbon G and the sheet thickness tb of the product region Gb, but also a transition region Gc ranging from the each end portion Ga in the width direction to the product region Gb increases. As a result, it is substantially difficult to ensure the product region Gb.

As a method of avoiding this problem, there may be employed a method of reducing the difference between the sheet thickness ta of the each end portion Ga in the width direction and the sheet thickness tb of the product region Gb by inhibiting the above-mentioned contraction of glass, specifically, by inhibiting contraction in the width direction of the glass ribbon G by the cooling rollers. However, as disclosed in Patent Literature 4, in the method of simply increasing the number of the cooling rollers, not only is it impossible to appropriately inhibit contraction in the width direction of the glass ribbon G, but also there arises a critical problem in that the apparatus is unnecessarily complicated and the frequency of maintenance and troubles extremely increases. Further, as disclosed in Patent Literature 5, according to the method of inclining the roller shafts of the cooling rollers, contraction in the width direction can be suppressed to some extent by imparting a stretching force in the width direction to the glass ribbon G, whereas the cooling rollers each have the same outer peripheral surface as that of an ordinary cooling roller. Therefore, slippage occurs between the cooling rollers and the each end portion Ga in the width direction of the glass ribbon G, which fails to appropriately inhibit contraction in the width direction of the glass ribbon G.

Note that, the above-mentioned pair of rolls disclosed in Patent Literature 6 are arrayed above the both end portions in the width direction of the glass ribbon flowing on the horizontal surface, and the pair of rolls are arranged so that a longitudinal direction of shafts is along the same direction as a flowing direction of the glass ribbon. Thus, when an attempt is made to apply the pair of rolls to the overflow down-draw method, in view of the configuration of the apparatus, it is substantially impossible to array the pair of rolls at the both end portions in the width direction of the glass ribbon so that the roll shafts extend in a vertical direction. In addition, if the pair of rolls are arrayed so that the roll shafts extend in the vertical direction, the pair of rolls cannot function as the cooling rollers used in the overflow down-draw method. That is, not only are the pair of rolls unable to exert original cooling action of the cooling rollers at an appropriate position in the vertical direction of the glass ribbon, but also it is ignored that the difference in sheet thickness between the both end portions in the width direction and the product region is determined depending on a relation between contraction in the width direction of the glass ribbon and the cooling action. In view of the above-mentioned matters, even if the pair of rolls are applied to the overflow down-draw method in which the cooling rollers are indispensable components, a large adverse effect inevitably occurs instead.

Note that, the above-mentioned problem may arise in the same way not only in a case of adopting the overflow down-draw method but also, for example, in a case of adopting the slot down-draw method that is common to the overflow down-draw method in that a sheet-like glass ribbon is produced while molten glass is caused to flow down from the forming body.

In view of the above-mentioned circumstances, the present invention has a technical object to apply appropriate action to each end portion in a width direction of a glass ribbon that is produced by causing molten glass to flow down from a forming body and to ensure a sufficiently large product region of the glass ribbon by improvement of the configuration of the cooling rollers.

### Solution to Problem

According to the present invention that has been made in order to achieve the above-mentioned technical object, provided is an apparatus for manufacturing a glass sheet, which has such structure that a pair of cooling rollers sandwich, from both front and back sides of a glass ribbon, each end portion in a width direction of the glass ribbon that is produced by causing molten glass to flow down from a forming body, and a roller shaft of each of the pair of cooling rollers is arrayed so as to extend from a center side to each end side in the width direction of the glass ribbon, in which each of the pair of cooling rollers catches the glass ribbon on an outer peripheral surface thereof, to thereby inhibit contraction in the width direction of the glass ribbon. Here, the “cooling roller” has structure actively performing cooling action, for example, structure having a hollow inside and allowing circulation of refrigerant such as water and the air.

With this configuration, the glass ribbon, which is produced by causing molten glass to flow down from the forming body, flows down while the each end portion in the width direction thereof is sandwiched by the pair of cooling rollers. However, each of the cooling rollers catches the glass ribbon (each end portion in the width direction of the glass ribbon) on the outer peripheral surface thereof, to thereby inhibit contraction in the width direction of the glass ribbon. That is, if left natural, the each end portion in the width direction of the glass ribbon, which contracts in the width direction, is caught on the outer peripheral surfaces of the cooling rollers, and hence it is possible to appropriately inhibit contraction in the width direction of the glass ribbon while suppressing slippage between the cooling rollers and the glass ribbon held in contact with the cooling rollers. With this, a force acts from the cooling rollers in a direction of inhibiting contraction in the width direction of the glass ribbon, in other words, a stretching force in the width direction acts on the glass ribbon. Thus, a sheet thickness of the each end portion in the width direction of the glass ribbon is thinned, a difference with a sheet thickness of a product region is reduced, and a transition region ranging from the each end portion in the width direction to the product region is reduced, with the result that it is possible to ensure the sufficiently large product region of the glass ribbon. Therefore, even if an amount of molten glass that is supplied to the forming body to flow down is increased, it is possible to avoid such a situation that the product region of the glass ribbon is narrowed, and to effectively increase a production amount of a glass sheet per unit time.

In this case, it is preferred that each of the pair of cooling rollers include a protrusion which is formed on the outer peripheral surface thereof and catches the glass ribbon.

With this configuration, the protrusion formed on the outer peripheral surface of each of the cooling rollers catches the each end portion in the width direction of the glass ribbon, to thereby inhibit contraction in the width direction of the glass ribbon. Further, owing to the presence of the protrusion, a contact area between the glass ribbon and the cooling rollers is increased, and hence a cooling effect with respect to the glass ribbon is enhanced, with the result that solidification is accelerated. Therefore, contraction in the width direction of the glass ribbon is inhibited more appropriately. In addition, a vicinity of a center of the product region of the glass ribbon is originally a region having high cooling rate, and a vicinity of the each end portion in the width direction of the glass ribbon also has high cooling rate owing to the presence of a plurality of protrusions formed on the outer peripheral surfaces of the cooling rollers. Thus, a difference in cooling history occurring between the vicinity of the center of the product region and the vicinity of the each end portion in the width direction is reduced, and along with this, it is possible to effectively avoid such a situation that unnecessary thermal stress occurs in the product region. Consequently, there is remarkably reduced a probability of occurrence of breakage of the glass ribbon, which is caused by an increase in the above-mentioned difference in cooling history and occurrence of thermal stress in the product region.

Here, the protrusion may include protrusions which are formed at a plurality of points on the outer peripheral surface of each of the cooling rollers in a scattered manner. Specifically, the protrusion may include a plurality of protrusions which are formed in each of a plurality of rows to be parallel with the roller shaft, or the protrusion may include a plurality of protrusions which are formed in each of a plurality of rows to be parallel with a circumferential direction. Alternatively, the protrusion may include a plurality of protrusions which are formed in each of a plurality of rows to be oblique relative to a circumferential direction. Note that, the “circumferential direction” described above means a direction along a border line at which the outer peripheral surface of each of the cooling rollers and a plane orthogonal to the roller shaft intersect (the same applies to the following description).

With this configuration, the plurality of protrusions which are formed on the outer peripheral surface of each of the cooling rollers in a scattered manner catch the each end portion in the width direction of the glass ribbon so as to inhibit contraction in the width direction of the glass ribbon, and owing to the presence of the plurality of protrusions, the contact area with the glass ribbon is increased, with the result that the cooling effect is remarkably increased. Note that, for an array state of the plurality of protrusions, it is preferred that, in order to relatively increase a surface area of the outer peripheral surface of each of the cooling rollers on a center side in the width direction of the glass ribbon, the protrusions be arrayed densely on the center side. Further, a shape of the protrusion is not particularly limited, but may be, for example, a conical shape, a hemispherical shape, a truncated cone shape, or a semicircular column shape. In addition, in a case where the plurality of protrusions are formed in each of a plurality of rows to be oblique relative to the circumferential direction, it is preferred that the protrusions be formed so that contact positions of the respective protrusions in the oblique rows with respect to the glass ribbon are gradually shifted from the each end side in the width direction of the glass ribbon to the center side along with rotation of the cooling roller. With this configuration, it is possible not only to inhibit, by the respective protrusions, contraction in the width direction of the glass ribbon along with the rotation of the cooling roller, but also to impart a stretching force of increasing its dimension in the width direction.

Further, the protrusion may include one or a plurality of ridges which are formed on the outer peripheral surface of each of the cooling rollers. Specifically, the protrusion may include a continuous protrusion which is formed in each of a plurality of rows to be parallel with a circumferential direction. Alternatively, the protrusion may be formed successively to be oblique relative to a circumferential direction of each of the pair of cooling rollers so that a contact position of the protrusion with respect to the glass ribbon is gradually shifted from the center side to the each end side in the width direction of the glass ribbon along with rotation of each of the pair of cooling rollers.

With this configuration, the one or the plurality of ridges which are formed on the outer peripheral surface of each of the cooling rollers catch the each end portion in the width direction of the glass ribbon so as to inhibit contraction in the width direction of the glass ribbon, and owing to the presence of the one or the plurality of ridges, the contact area with the glass ribbon is increased, with the result that the cooling effect is remarkably increased. In addition, in a case where the ridges are formed successively to be oblique relative to the circumferential direction of each of the pair of cooling rollers, it is possible not only to inhibit, by the respective ridges, contraction in the width direction of the glass ribbon along with the rotation of the cooling roller, but also to impart a stretching force of increasing its dimension in the width direction. Note that, for a formation state of the one or the plurality of ridges, it is preferred that the ridges be formed in order to relatively increase the surface area of the outer peripheral surface of each of the cooling rollers on the center side in the width direction of the glass ribbon.

Meanwhile, instead of forming the protrusion on the outer peripheral surface of each of the cooling rollers as described above, the outer peripheral surface of each of the pair of cooling rollers may include a tapered surface which gradually decreases in diameter from the center side to the each end side in the width direction of the glass ribbon and catches the glass ribbon.

With this configuration, the tapered surface of the outer peripheral surface of each of the cooling rollers catches the each end portion in the width direction of the glass ribbon so as to inhibit contraction in the width direction of the glass ribbon. Note that, the above-mentioned protrusion may be formed on the tapered surface for increasing the cooling effect.

In the above-mentioned configuration, the roller shaft of each of the pair of cooling rollers may be arrayed so as to be inclined gradually upward from the center side to the each end side in the width direction of the glass ribbon.

With this configuration, it is possible to inhibit contraction in the width direction of the glass ribbon to some extent only by inclining the roller shaft of each of the cooling rollers in the above-mentioned predetermined direction, and hence it is possible to inhibit contraction in the width direction of the glass ribbon more reliably in combination with provision of a catching portion formed of the above-mentioned protrusion or tapered surface on the outer peripheral surface of each of the cooling rollers.

In addition, in the above-mentioned configuration, it is preferred that a dimension in the width direction of the glass ribbon be 2000 mm or more.

As described above, when the dimension in the width direction of the glass ribbon is a long dimension of 2000 mm or more, it is possible to adequately ensure the above-mentioned operational effect.

### Advantageous Effects of Invention

As described above, according to the present invention, a force acts from the cooling rollers in a direction of inhibiting contraction in the width direction of the glass ribbon. Thus, a sheet thickness of the each end portion in the width direction of the glass ribbon is thinned, a difference with a sheet thickness of a product region is reduced, and a transition region ranging from the each end portion in the width direction to the product region is also reduced, with the result that it is possible to ensure the sufficiently large product region of the glass ribbon. Therefore, even if an amount of molten glass that is supplied to the forming body to flow down is increased, it is possible to avoid such a situation that the product region of the glass ribbon is narrowed, and to effectively increase a production amount of a glass sheet per unit time.

### BRIEF DESCRIPTION OF DRAWINGS

FIG. 1 A schematic front view illustrating a main part of an apparatus for manufacturing a glass sheet according to a first embodiment of the present invention.

FIG. 2 A perspective view illustrating a main part of a cooling roller used in the apparatus for manufacturing a glass sheet according to the first embodiment.

FIG. 3 A lateral plan view illustrating a state in which a glass ribbon is sandwiched by the cooling rollers used in the apparatus for manufacturing a glass sheet according to the first embodiment.

FIG. 4 A perspective view illustrating a main part of a cooling roller used in an apparatus for manufacturing a glass sheet according to a second embodiment of the present invention.

FIG. 5 A perspective view illustrating a main part of a cooling roller used in an apparatus for manufacturing a glass sheet according to a third embodiment of the present invention.

FIG. 6 A perspective view illustrating a main part of a cooling roller used in an apparatus for manufacturing a glass sheet according to a fourth embodiment of the present invention.

FIG. 7 A perspective view illustrating a main part of a cooling roller used in an apparatus for manufacturing a glass sheet according to a fifth embodiment of the present invention.

FIG. 8 A perspective view illustrating a main part of a cooling roller used in an apparatus for manufacturing a glass sheet according to a sixth embodiment of the present invention.

FIG. 9 A perspective view illustrating a main part of a cooling roller used in an apparatus for manufacturing a glass sheet according to a seventh embodiment of the present invention.

FIG. 10 A lateral plan view illustrating a state in which the glass ribbon is sandwiched by the cooling rollers used in the apparatus for manufacturing a glass sheet according to the seventh embodiment.

FIG. 11 A schematic front view illustrating a main part of an apparatus for manufacturing a glass sheet according to an eighth embodiment of the present invention.

FIG. 12 A lateral plan view of the glass ribbon illustrating a conventional problem.

FIG. 13 A lateral plan view of the glass ribbon illustrating a conventional problem.

### DESCRIPTION OF EMBODIMENTS

In the following, an apparatus for manufacturing a glass sheet according to embodiments of the present invention is described with reference to the attached drawings.

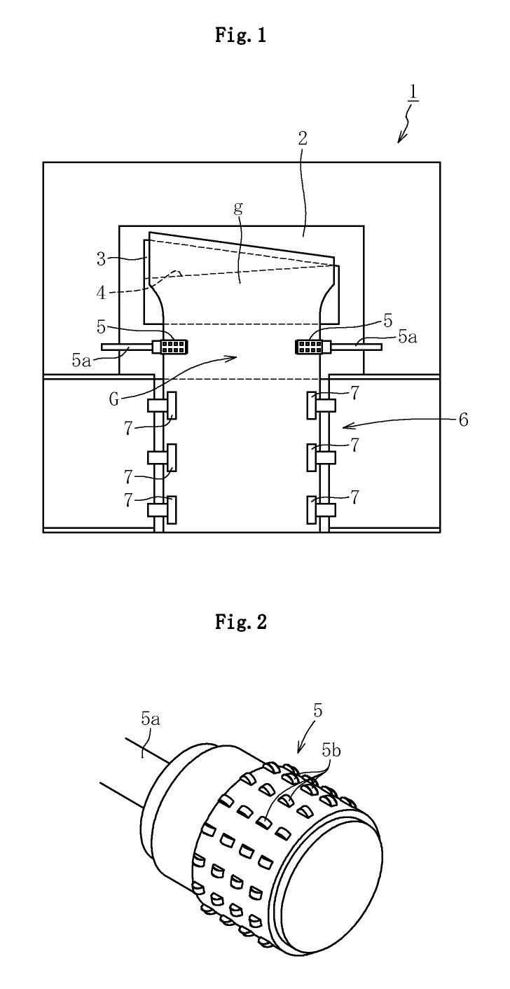

FIG. 1 is a schematic front view illustrating a main part of an apparatus for manufacturing a glass sheet according to a first embodiment of the present invention, and illustrates an example of a process of manufacturing a glass sheet by an overflow down-draw method. As illustrated in FIG. 1, this apparatus 1 for manufacturing a glass sheet includes, inside a forming furnace 2, a forming trough (forming body) 3 having a wedge-shaped cross-section (cross-section orthogonal to the drawing sheet) which gradually decreases in width downward, and a groove 4 with an upward opening portion is formed in the forming trough 3. Further, molten glass is supplied to the groove 4 of the forming trough 3, and molten glass g overflowing from the upward opening portion of the groove 4 flows down along both side surfaces of the forming trough 3 (side surfaces on a front side and a back side of the drawing sheet), and further flows down after interflowing at a lower end of the forming trough 3, to thereby produce a sheet-like glass ribbon G.

In a process in which the glass ribbon G flows down, directly below the forming trough 3, each end portion in the width direction of the glass ribbon G is sandwiched from both front and back sides thereof by a pair of cooling rollers 5, and even inside an annealer 6 provided below the cooling rollers, the each end portion in the width direction of the glass ribbon G is sandwiched from the both front and back sides thereof by pairs of annealing rollers 7 which are arrayed in a plurality of stages. Therefore, between the forming trough 3 and the annealer 6, the cooling rollers 5 include one pair of cooling rollers at a left end portion of the glass ribbon G and one pair of cooling rollers at a right end portion thereof, that is, include two pairs in total.

The structure of the cooling roller 5 is described in detail. As illustrated in FIG. 2, on an outer peripheral surface of the cooling roller 5 including a roller shaft (rotation drive shaft) 5a at one end side thereof, there are formed a plurality of protrusions 5b as catching portions for inhibiting contraction in the width direction of the glass ribbon G. That is, the plurality of protrusions 5b have such a shape as to catch the each end portion in the width direction of the glass ribbon G in a direction of inhibiting contraction in the width direction of the glass ribbon G. Specifically, each of the protrusions 5b has a semicircular column shape, and each end surface of the protrusion 5b having a semicircular column shape is formed as a flat surface forming a step in a circumferential direction. Accordingly, a circular arc surface of the protrusion 5b having a semicircular column shape functions as the catching portion for inhibiting contraction in the width direction of the glass ribbon G.

Further, the protrusions 5b having a semicircular column shape are formed on the outer peripheral surface of the cooling roller 5 in each of a plurality of rows to be parallel with the roller shaft 5a. Note that, in the illustrated example, the protrusions 5b are formed in a plurality of rows to be parallel with the circumferential direction. However, the protrusions 5b do not need to be aligned in parallel with the circumferential direction, but may be arrayed in a zigzag manner or an oblique manner in the circumferential direction. Further, the shape of the protrusion 5b is not limited to a semicircular column shape, but may be a conical shape, a hemispherical shape, or a truncated cone shape, and may be a cubic shape, a rectangular parallelepiped shape, or the like (the same applies to the following embodiments).

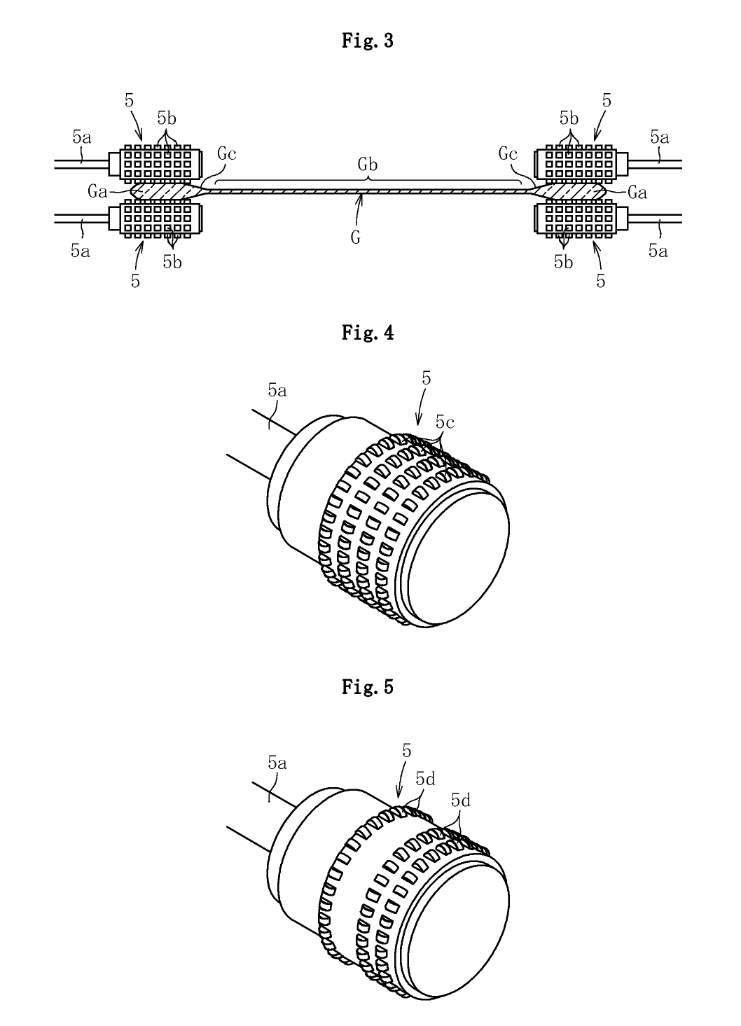

With this configuration, the glass ribbon G, which is present between the forming trough 3 and the annealer 6, is likely to contract in the width direction. However, as illustrated in FIG. 3, each end portion Ga in the width direction, at which a sheet thickness of the glass ribbon G is relatively thick, is sandwiched by the pair of cooling rollers 5 from the front and back sides thereof, and thus the plurality of protrusions 5b formed on the outer peripheral surfaces of the pair of cooling rollers 5 catch the each end portion Ga in the width direction of the glass ribbon G. With this configuration, a force acts from the cooling rollers 5 in the direction of inhibiting contraction in the width direction of the glass ribbon G, and hence the sheet thickness of the each end portion Ga in the width direction of the glass ribbon G is thinned. As a result, a difference with a sheet thickness of a product region Gb is reduced, and a transition region Gc ranging from the each end portion Ga in the width direction to the product region Gb is also reduced, which enables the sufficiently large product region Gb of the glass ribbon G to be ensured.

Moreover, owing to the presence of the plurality of protrusions 5b formed on the outer peripheral surfaces of the cooling rollers 5, a contact area between the each end portion Ga in the width direction of the glass ribbon G and the cooling rollers 5 is increased, and hence a cooling effect with respect to the glass ribbon G is enhanced, with the result that solidification is accelerated. Therefore, contraction in the width direction of the glass ribbon G is inhibited more reliably. In addition, a vicinity of the center of the product region Gb of the glass ribbon G is originally a region having high cooling rate, and a vicinity of the each end portion Ga in the width direction of the glass ribbon G also has high cooling rate owing to the presence of the plurality of protrusions 5b of the cooling rollers 5. Thus, a difference in cooling history occurring between the vicinity of the center of the product region Gb and the vicinity of the each end portion Ga in the width direction is reduced, and unnecessary thermal stress is unlikely to occur in the product region Gb. Consequently, a probability of occurrence of breakage of the glass ribbon G due to thermal stress is remarkably reduced.

FIG. 4 is a perspective view illustrating a main part of the cooling roller 5 to be placed in an apparatus for manufacturing a glass sheet according to a second embodiment of the present invention. The cooling roller 5 according to the second embodiment is different from the cooling roller 5 according to the above-mentioned first embodiment in that a plurality of protrusions 5c are formed densely on the outer peripheral surface of the cooling roller 5, and that basically, the plurality of protrusions 5c are formed in each of a plurality of rows to be parallel with the circumferential direction. Note that, in the illustrated example, the protrusions 5c are formed in a plurality of rows to be parallel also to the roller shaft 5a, but do not need to be aligned in a direction of the roller shaft 5a. Other configuration and operational effect are the same as those of the above-mentioned first embodiment, and hence description thereof is omitted.

FIG. 5 is a perspective view illustrating a main part of the cooling roller 5 to be placed in an apparatus for manufacturing a glass sheet according to a third embodiment of the present invention. The cooling roller 5 according to the third embodiment is different from the cooling roller 5 according to each of the above-mentioned first and second embodiments in that a plurality of protrusions 5d are formed densely on the outer peripheral surface of the cooling roller 5 on the center side in the width direction of the glass ribbon G and the plurality of protrusions 5d are formed coarsely on each end side in the width direction of the glass ribbon G. With this configuration, cooling action is more preferably performed on the each end portion Ga in the width direction of the glass ribbon G, which is further advantageous in ensuring the large product region Gb. Other configuration and operational effect are the same as those of the above-mentioned first embodiment, and hence description thereof is omitted.

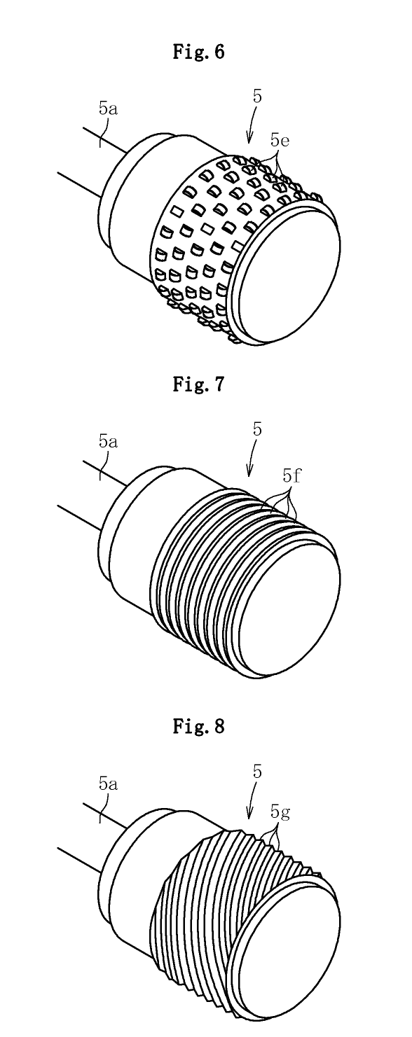

FIG. 6 is a perspective view illustrating a main part of the cooling roller 5 to be placed in an apparatus for manufacturing a glass sheet according to a fourth embodiment of the present invention. The cooling roller 5 according to the fourth embodiment is different from the cooling roller 5 according to each of the above-mentioned first and second embodiments in that a plurality of protrusions 5e are formed in each of a plurality of rows to be oblique relative to the circumferential direction, and that the protrusions 5e are formed so that contact positions of the respective protrusions 5e in the oblique rows with respect to the glass ribbon G are gradually shifted from the center side to the each end side in the width direction of the glass ribbon G along with rotation of the cooling roller 5. With this configuration, it is possible not only to inhibit, by the respective protrusions 5e, contraction in the width direction of the glass ribbon G along with the rotation of the cooling roller 5, but also to impart a stretching force of increasing its dimension in the width direction. Other configuration and operational effect are the same as those of the above-mentioned first embodiment, and hence description thereof is omitted.

FIG. 7 is a perspective view illustrating a main part of the cooling roller 5 to be placed in an apparatus for manufacturing a glass sheet according to a fifth embodiment of the present invention. The cooling roller 5 according to the fifth embodiment is different from the cooling roller 5 according to each of the above-mentioned first and second embodiments (in particular, second embodiment) in that protrusions 5f are continuously formed in each of a plurality of rows to be parallel with the circumferential direction, that is, different in that the plurality of protrusions 5f are formed in the form of ridges parallel with the circumferential direction. With this configuration, the respective ridges 5f function as the catching portions for inhibiting contraction in the width direction of the glass ribbon G. Note that, also in this case, the respective ridges 5e may be arrayed more densely on the center side of the glass ribbon G than on the each end side thereof. Other configuration and operational effect are the same as those of the above-mentioned first embodiment, and hence description thereof is omitted.

FIG. 8 is a perspective view illustrating a main part of the cooling roller 5 to be placed in an apparatus for manufacturing a glass sheet according to a sixth embodiment of the present invention. The cooling roller 5 according to the sixth embodiment is different from the cooling roller 5 according to each of the above-mentioned first and second embodiments in that the protrusions 5g are formed successively and obliquely relative to the circumferential direction of the cooling roller 5 so that the contact positions of the protrusions 5g with respect to the glass ribbon G are gradually shifted from the center side to the each end side in the width direction of the glass ribbon G along with rotation of the cooling roller 5, that is, different in that the protrusions 5g are constituted by a plurality of ridges and the ridges 5g are formed at the predetermined angle in a spiral manner. Note that, in this case, one ridge 5g may be formed at the predetermined angle in a spiral manner. Also in this case, one or a plurality of ridges 5g function as the catching portions for inhibiting contraction in the width direction of the glass ribbon G. With this configuration, it is possible not only to inhibit, by the respective ridges 5g, contraction in the width direction of the glass ribbon G along with the rotation of the cooling roller 5, but also to impart the stretching force of increasing its dimension in the width direction. Other configuration and operational effect are the same as those of the above-mentioned first embodiment, and hence description thereof is omitted.

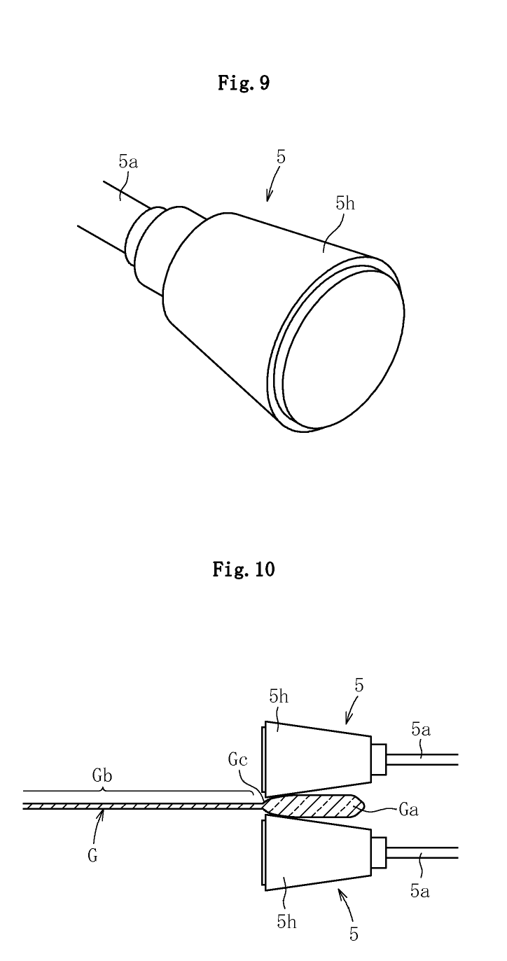

FIG. 9 is a perspective view illustrating a main part of the cooling roller 5 to be placed in an apparatus for manufacturing a glass sheet according to a seventh embodiment of the present invention. The cooling roller 5 according to the seventh embodiment is different from the cooling roller 5 according to each of the first to sixth embodiments in that the outer peripheral surface of the cooling roller 5 has a tapered surface 5h which gradually decreases in diameter from the center side to the each end side in the width direction of the glass ribbon G and catches the glass ribbon G. Even in this case, as illustrated in FIG. 10, the tapered surfaces 5h of the cooling rollers 5 function as the catching portions for inhibiting contraction in the width direction of the glass ribbon G. With this configuration, though it is difficult to enhance the cooling effect by increasing the surface area of the outer peripheral surface of the cooling roller 5, it is possible to achieve enhancement of the cooling effect by increasing the surface area if the above-mentioned protrusions 5b, 5c, 5d, or 5e or the ridges 5f or 5g are formed on the tapered surface 5h. Other configuration and operational effect are the same as those of the above-mentioned first embodiment, and hence description thereof is omitted.

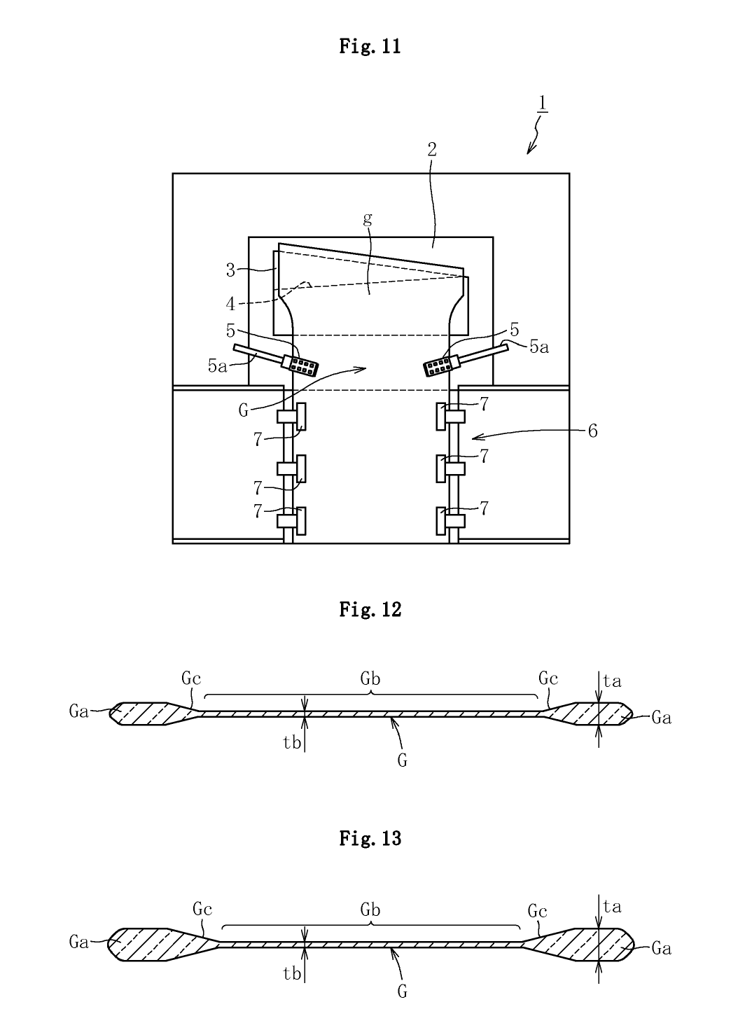

FIG. 11 is a schematic front view illustrating a main part of the apparatus 1 for manufacturing a glass sheet, which uses cooling rollers according to an eighth embodiment of the present invention. The cooling rollers 5 according to the eighth embodiment are different from the above-mentioned cooling rollers 5 according to the first embodiment illustrated in FIG. 1 in that the roller shafts 5a of the cooling rollers 5 are arrayed so as to be inclined gradually upward from the center side to the each end side in the width direction of the glass ribbon G. In this case, because the cooling rollers 5 rotate while being held in contact with the flowing-down glass ribbon G, when the cooling rollers 5 rotate about the roller shafts 5a inclined in the predetermined direction, the stretching force in the width direction is imparted to the glass ribbon G. Therefore, in combination with formation of the above-mentioned protrusions 5b, 5c, 5d, or 5e or the ridges 5f or 5g on the outer peripheral surface of the cooling roller 5, or formation of the tapered surface 5h, contraction in the width direction of the glass ribbon G is inhibited more reliably, and the product region Gb is still further enlarged.

### Example 1

The inventors of the present invention compared, based on a glass ribbon that solidified after passing through the cooling rollers, an apparatus for manufacturing a glass sheet, which includes the above-mentioned various cooling rollers, and an apparatus for manufacturing a glass sheet, which includes cooling rollers having a smooth outer peripheral surface. When making this comparison, under a condition that an entire length in the width direction of the glass ribbon is 3,000 mm and a sheet thickness at a center portion in a product region of the glass ribbon is 0.7 mm, the glass ribbon was produced while keeping constant a flow rate of molten glass that flows down from a forming trough. Further, each cooling roller has a diameter of 50 mm, a cylindrical shape, and a hollow inside, and has structure allowing circulation of refrigerant such as water and the air.

Here, as Example 1 of the present invention, there was used a cooling roller having a so-called shaft parallel array of semicircular columnar protrusions, in which a plurality of semicircular columnar protrusions are arrayed on the outer peripheral surface in a plurality of rows to be parallel with the roller shaft as illustrated in FIG. 2. As Example 2 of the present invention, there was used a cooling roller having a so-called spiral array of semicircular columnar protrusions, in which a plurality of semicircular columnar protrusions are arrayed on the outer peripheral surface in a spiral manner to be oblique relative to the circumferential direction as illustrated in FIG. 6. As Example 3 of the present invention, there was used a cooling roller having a so-called annular array of semicircular columnar protrusions, in which a plurality of semicircular columnar protrusions are arrayed on the outer peripheral surface in a plurality of rows to be parallel with the circumferential direction as illustrated in FIG. 4. As Example 4 of the present invention, there was used a cooling roller having so-called screw-shaped protrusions, in which a plurality of ridges are arrayed on the outer peripheral surface in a spiral manner to be oblique relative to the circumferential direction as illustrated in FIG. 8. As Example 5 of the present invention, there was used a cooling roller having so-called ring-shaped protrusions, in which a plurality of ridges are arrayed on the outer peripheral surface to be parallel with the circumferential direction as illustrated in FIG. 7. Further, as Comparative Example, there was used a cooling roller having an outer peripheral surface as a smooth cylindrical surface. Note that, all the cooling rollers each have the roller shaft extending in a horizontal direction as illustrated in FIG. 1.

Regarding glass ribbons manufactured using the above-mentioned cooling rollers according to Examples 1 to 5 and Comparative Example, a sheet thickness of each end portion in the width direction, an expansion ratio of the product region in a case of using Comparative Example as the reference, and residual thermal stress of the product region were measured. The results are shown in Table 1 below. Note that, in Table 1 below, a mark Δ represents an ordinary result, a mark ◯ represents a good result, a mark ⊚ represents an excellent result, and a mark x represents a poor result.

TABLE 1

| | Example 1 | Example 2 | Example 3 | | | |
|---|---|---|---|---|---|---|
| | Shaft parallel | Spiral | Annular | | | |
| | array of | array of | array of | Example 4 | Example 5 | Comparative |
| | semicircular | semicircular | semicircular | Screw- | Ring- | Example |
| | columnar | columnar | columnar | shaped | shaped | No |
| | protrusions | protrusions | protrusions | protrusions | protrusions | protrusion |
| Sheet thickness | 2.6 mm | 2.1 mm | 2.7 mm | 1.8 mm | 2.7 mm | 3.0 mm |
| of each end region | | | | | | |
| Expansion ratio | 0.7% | 1.1% | 0% | 1.9% | 0.4% | — |
| of product region (%) | | | | | | |
| Residual stress | Δ | ◯ | Δ | ⊚ | Δ | X |

With reference to Table 1 above, in Examples 1 to 5 of the present invention, contraction in the width direction of the glass ribbon is inhibited, and each end portion in the width direction of the glass ribbon is efficiently cooled. Consequently, the sheet thickness of the each end portion in the width direction thereof is thinned, and it is possible to grasp that good result is shown in residual stress. In particular, in Example 2 and Example 5, a force of stretching the width of the glass ribbon acts, to thereby increase the width of the product region of the glass ribbon. Thus, it is also possible to grasp that the transition region is reduced.

### REFERENCE SIGNS LIST

1 apparatus for manufacturing glass sheet
3 forming trough (forming body)
5 cooling roller
5a roller shaft
5b, 5c, 5d, 5e protrusion
5f, 5g protrusion (ridge)
5h tapered surface
G glass ribbon
Ga each end portion in width direction of glass ribbon
Gb product region of glass ribbon
Gc transition region of glass ribbon

1. An apparatus for manufacturing a glass sheet, which has such structure that a pair of cooling rollers sandwich, from both front and back sides of a glass ribbon, each end portion in a width direction of the glass ribbon that is produced by causing molten glass to flow down from a forming body, and a roller shaft of each of the pair of cooling rollers is arrayed so as to extend from a center side to each end side in the width direction of the glass ribbon,
wherein each of the pair of cooling rollers catches the glass ribbon on an outer peripheral surface thereof, to thereby inhibit contraction in the width direction of the glass ribbon.

2. The apparatus for manufacturing a glass sheet according to claim 1, wherein each of the pair of cooling rollers comprises a protrusion which is formed on the outer peripheral surface thereof and catches the glass ribbon.

3. The apparatus for manufacturing a glass sheet according to claim 2, wherein the protrusion comprises a plurality of protrusions which are formed on the outer peripheral surface of each of the pair of cooling rollers in each of a plurality of rows to be parallel with the roller shaft.

4. The apparatus for manufacturing a glass sheet according to claim 2, wherein the protrusion comprises a plurality of protrusions which are formed on the outer peripheral surface of each of the pair of cooling rollers in each of a plurality of rows to be parallel with a circumferential direction.

5. The apparatus for manufacturing a glass sheet according to claim 2, wherein the protrusion comprises a plurality of protrusions which are formed on the outer peripheral surface of each of the pair of cooling rollers in each of a plurality of rows to be oblique relative to a circumferential direction.

6. The apparatus for manufacturing a glass sheet according to claim 2, wherein the protrusion comprises a continuous protrusion which is formed on the outer peripheral surface of each of the pair of cooling rollers in each of a plurality of rows to be parallel with a circumferential direction.

7. The apparatus for manufacturing a glass sheet according to claim 2, wherein the protrusion is formed successively on the outer peripheral surface of each of the pair of cooling rollers to be oblique relative to a circumferential direction of each of the pair of cooling rollers so that a contact position of the protrusion with respect to the glass ribbon is gradually shifted from the center side to the each end side in the width direction of the glass ribbon along with rotation of each of the pair of cooling rollers.

8. The apparatus for manufacturing a glass sheet according to claim 1, wherein the outer peripheral surface of each of the pair of cooling rollers comprises a tapered surface which gradually decreases in diameter from the center side to the each end side in the width direction of the glass ribbon and catches the glass ribbon.

9. The apparatus for manufacturing a glass sheet according to claim 1, wherein the roller shaft of each of the pair of cooling rollers is arrayed so as to be inclined gradually upward from the center side to the each end side in the width direction of the glass ribbon.

10. The apparatus for manufacturing a glass sheet according to claim 1, wherein a dimension in the width direction of the glass ribbon is 2,000 mm or more.

11. The apparatus for manufacturing a glass sheet according to claim 2, wherein the roller shaft of each of the pair of cooling rollers is arrayed so as to be inclined gradually upward from the center side to the each end side in the width direction of the glass ribbon.

12. The apparatus for manufacturing a glass sheet according to claim 3, wherein the roller shaft of each of the pair of cooling rollers is arrayed so as to be inclined gradually upward from the center side to the each end side in the width direction of the glass ribbon.

13. The apparatus for manufacturing a glass sheet according to claim 4, wherein the roller shaft of each of the pair of cooling rollers is arrayed so as to be inclined gradually upward from the center side to the each end side in the width direction of the glass ribbon.

14. The apparatus for manufacturing a glass sheet according to claim 5, wherein the roller shaft of each of the pair of cooling rollers is arrayed so as to be inclined gradually upward from the center side to the each end side in the width direction of the glass ribbon.

15. The apparatus for manufacturing a glass sheet according to claim 6, wherein the roller shaft of each of the pair of cooling rollers is arrayed so as to be inclined gradually upward from the center side to the each end side in the width direction of the glass ribbon.

16. The apparatus for manufacturing a glass sheet according to claim 7, wherein the roller shaft of each of the pair of cooling rollers is arrayed so as to be inclined gradually upward from the center side to the each end side in the width direction of the glass ribbon.

17. The apparatus for manufacturing a glass sheet according to claim 8, wherein the roller shaft of each of the pair of cooling rollers is arrayed so as to be inclined gradually upward from the center side to the each end side in the width direction of the glass ribbon.

18. The apparatus for manufacturing a glass sheet according to claim 2, wherein a dimension in the width direction of the glass ribbon is 2,000 mm or more.

19. The apparatus for manufacturing a glass sheet according to claim 3, wherein a dimension in the width direction of the glass ribbon is 2,000 mm or more.

20. The apparatus for manufacturing a glass sheet according to claim 4, wherein a dimension in the width direction of the glass ribbon is 2,000 mm or more.
